(19) United States
(12) Patent Application Publication
(10) Pub. No.: US 2026/0222958 A1
(43) Pub. Date: Jul. 30, 2026

(54) HANDLING RADIO LINK FAILURE WHILE PERFORMING LOWER LAYER TRIGGERED MOBILITY IN TELECOMMUNICATION NETWORK

(71) Applicant: Samsung Electronics Co., Ltd., Suwon-si, Gyeonggi-do (KR)

(72) Inventor: Aby Kanneath ABRAHAM, Bangalore (IN)

(21) Appl. No.: 19/147,573

(22) PCT Filed: Jan. 9, 2024
(86) PCT No.: PCT/KR2024/000425

§ 371 Date: Jul. 11, 2025

(30) Foreign Application Priority Data
Jan. 12, 2023 (IN) 202341002607
Dec. 8, 2023 (IN) 2023 41002607

(51) Int. Cl. H04W 36/30

(52) U.S. Cl. CPC H04W 36/305

(57) ABSTRACT

The disclosure relates to a 5G or 6G communication system for supporting a higher data transmission rate. A method by a user equipment (UE) associated with a first cell group and a second cell group in a wireless communication system, the UE comprising, receiving, from a base station, a control message including a lower layer triggered mobility (LTM) configuration for performing a LTM measurement and a timer for supervising a LTM cell switch, detecting a radio link failure for the first cell group of the first cell group and the second cell group, while performing a LTM cell switch, identifying whether the timer for supervising the LTM cell switch is running on the second cell group, and transmitting, to the base station, a radio resource control (RRC) reestablishment message, in case that the timer for supervising the LTM cell switch is running on the second cell group.

### TECHNICAL FIELD

The present disclosure relates to the field of wireless communication and more specifically, handling radio link failure while performing lower layer triggered mobility in telecommunication network.

### BACKGROUND ART

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultrahigh-performance communication and computing resources.

In wireless technologies such as 5G New Radio devices, mobility is achieved through cell reselection in RRC_IDLE mode. Prior to NR Release 17, handover was the preferred method in RRC_CONNECTED mode, which required explicit RRC signalling triggered by a gNB. This network-controlled mobility involves a three-step handover process, consisting of preparation, execution, and completion. The gNB may configure the UE to report measurements, or use its own understanding of network topology to send an RRC Reconfiguration message to handover the UE to a target cell. Alternatively, in NR Release 16, the gNB may configure the UE with execution conditions for triggering handover and the RRC Reconfiguration message to be executed when the execution conditions are met. Once these conditions are met, the UE may move to the target cell, apply the RRC Reconfiguration message and send the RRC Reconfiguration complete message. The 3GPP also introduced a new handover method, called Dual Active Protocol Stack handover, in NR Release 16. However, these methods rely on layer 3 (RRC) messages, which can result in significant signalling overhead and latency issues. As such, there is a growing need to address these concerns and reduce signalling overhead and latency.

### DISCLOSURE OF INVENTION

### Technical Problem

The present disclosure relates to wireless communication systems and, more specifically, the invention relates to handling radio link failure while performing lower layer triggered mobility in telecommunication network.

It is desired to address the above-mentioned disadvantages or other short comings or at least provide a useful alternative.

The principal object of the embodiments herein is to provide a method and a UE for handling a cell group failure while performing lower layer triggered mobility in a telecommunication network.

Another object of the embodiments herein is to receive a LTM configuration for performing LTM measurement and a timer for supervising a LTM cell switch from a network apparatus in the telecommunication network.

Another object of the embodiments herein is to determine whether the timer for supervising a LTM cell switch procedure is running on other cell group.

Yet, another object of the embodiments herein is to transmit a RRC reestablishment message to the network apparatus, when the timer for supervising the LTM cell switch procedure is running on the other cell group.

Yet, another object of the embodiments herein is to transmit a cell group failure information message to the network apparatus, when the timer for supervising the LTM cell switch procedure is not running.

Yet, another object of the embodiments herein is to store the LTM configuration for the at least one cell group, and a current LTM candidate cell configuration of at least one candidate cell belonging to the at least one cell group in a memory of the UE.

Yet, another object of the embodiments herein is to stop the LTM measurement for the at least one cell group based on the LTM configuration upon transmitting the cell group failure information by determining content of the cell group failure information.

Yet, another object of the embodiments herein is to handle SCG and MCG failures when UE is configured to perform LTM measurements or upon receiving cell switch for LTM.

### Solution to Problem

Accordingly, the embodiment herein is to provide a method for handling a radio link failure (RLF) while performing lower layer triggered mobility (LTM) in a telecommunication network. The method includes receiving, by a UE, a LTM configuration for performing LTM measurement and a timer for supervising a LTM cell switch from a network apparatus in the telecommunication network. Further, the method includes detecting, by the UE, a RLF of at least one cell group. Further, the method includes determining, by the UE, whether the timer for supervising a LTM cell switch procedure is running on other cell group. Further, the method includes performing, by the UE, one of: transmitting a RRC reestablishment message to the network apparatus, when the timer for supervising the LTM cell switch procedure is running on the other cell group, and transmitting a cell group failure information message to the network apparatus, when the timer for supervising the LTM cell switch procedure is not running.

In an embodiment, the cell group is at least one of a Master Cell Group (MCG) and a Secondary Cell Group (SCG).

In an embodiment, the network apparatus is one of a Master Node (MN) and a Secondary Node (SN).

In an embodiment, the timer for supervising the LTM cell switch procedure is T304 and the cell group failure information is MCGFailureInformation when the cell group is MCG and the cell group failure information is SCGFailureInformation when the cell group is SCG.

In an embodiment, transmitting the cell group failure information message to the network apparatus includes creating, by the UE, the cell group failure information message by including the LTM measurement, where the LTM measurement includes a candidate cell identifier of at least one candidate cell belonging to the at least one cell group and the L1 measurements, and transmitting, by the UE, the cell group failure information message including the LTM measurement to the network apparatus.

In an embodiment, the LTM measurement is a latest LTM measurement of the at least one cell group.

In an embodiment, the LTM measurement is one of a periodic measurement, an aperiodic measurement, a semi periodic measurement, and an event-based measurement performed by the UE as configured by the network apparatus for the LTM.

In an embodiment, the LTM measurement is one of: a Reference Signal Received Power (RSRP) measurement, a Signal to Interference and Noise Ratio (SINR) measurement, and a Reference Signal Received Quality (RSRQ) measurement.

In an embodiment, the method includes storing, by the UE, the LTM configuration for the at least one cell group, and a current LTM candidate cell configuration of at least one candidate cell belonging to the at least one cell group in a memory of the UE. The current LTM candidate cell configuration of the at least one candidate cell is received from the network apparatus. Further, the method includes stopping, by the UE, the LTM measurement for the at least one cell group based on the LTM configuration upon transmitting the cell group failure information by determining content of the cell group failure information.

Accordingly, the embodiment herein is to provide a UE for handling a radio link failure while performing LTM in a telecommunication network. The UE includes a LTM and cell group failure controller coupled to a memory and a processor. The LTM and cell group failure controller is configured to receive a LTM configuration for performing LTM measurement and a timer for supervising a LTM cell switch from a network apparatus in the telecommunication network. Further, the LTM and cell group failure controller is configured to detect a RLF of at least one cell group. Further, the LTM and cell group failure controller is configured to determine whether the timer for supervising a LTM cell switch procedure is running on other cell group. In an embodiment, the LTM and cell group failure controller is configured to transmit a RRC reestablishment message to the network apparatus, when the timer for supervising the LTM cell switch procedure is running on the other cell group. In another embodiment, the LTM and cell group failure controller is configured to transmit a cell group failure information message to the network apparatus, when the timer for supervising the LTM cell switch procedure is not running.

Accordingly, the embodiment herein is to provide a method for handling a radio link failure while performing LTM in a telecommunication network. The method includes receiving, by a network apparatus, one of a MCGFailureInformation comprising a LTM measurement and a SCGFailureInformation comprising the LTM measurement from a UE. Further, the method includes performing, by the network apparatus, one of: sending a MCG reconfiguration message to recover a MCG link based on the MCGFailureInformation, and sending a SCG reconfiguration message to recover a SCG link based on the SCGFailureInformation.

In an embodiment, the network apparatus receives one of: the MCGFailureInformation comprising the LTM measurement and the SCGFailureInformation comprising the LTM measurement from the UE, when a timer for supervising a LTM cell switch procedure is not running.

Accordingly, the embodiment herein is to provide a network apparatus for handling a radio link failure while performing LTM in a telecommunication network. The network apparatus includes a LTM and cell group failure controller coupled to a memory and a processor. The LTM and cell group failure controller is configured to receive one of a MCGFailureInformation comprising LTM measurements and a SCGFailureInformation comprising the LTM measurements from a UE. In an embodiment, the LTM and cell group failure controller is configured to send a MCG reconfiguration message to recover a MCG link based on the MCGFailureInformation. In another embodiment, the LTM and cell group failure controller is configured to send a SCG reconfiguration message to recover a SCG link based on the SCGFailureInformation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein and the embodiments herein include all such modifications.

In an embodiment, a method by a user equipment (UE) associated with a first cell group and a second cell group in a wireless communication system, the UE comprising: receiving, from a base station, a control message including a lower layer triggered mobility (LTM) configuration for performing a LTM measurement and a timer for supervising a LTM cell switch; detecting a radio link failure for the first cell group of the first cell group and the second cell group, while performing a LTM cell switch; identifying whether the timer for supervising the LTM cell switch is running on the second cell group; and transmitting, to the base station, a radio resource control (RRC) reestablishment message, in case that the timer for supervising the LTM cell switch is running on the second cell group.

In another embodiment, a method by a base station in a wireless communication system, the base station comprising: transmitting, to a user equipment (UE), a control message including a lower layer triggered mobility (LTM) configuration for performing a LTM measurement and a timer for supervising a LTM cell switch; and receiving, from the UE, a radio resource control (RRC) reestablishment message, in case that the timer for supervising the LTM cell switch is running on a second cell group, wherein the UE is associated with a first cell group and the second cell group, wherein the UE detect a radio link failure for the first cell group of the first cell group and the second cell group, while performing a LTM cell switch, wherein the UE identify whether the timer for supervising the LTM cell switch is running on the second cell group.

In yet another embodiment, a user equipment (UE) associated with a first cell group and a second cell group in a wireless communication system, the UE comprising: a transceiver; and a processor configured to: receive, from a base station, a control message including a lower layer triggered mobility (LTM) configuration for performing a LTM measurement and a timer for supervising a LTM cell switch, detect a radio link failure for the first cell group of the first cell group and the second cell group, while performing a LTM cell switch, identify whether the timer for supervising the LTM cell switch is running on the second cell group, and transmit, to the base station, a radio resource control (RRC) reestablishment message, in case that the timer for supervising the LTM cell switch is running on the second cell group.

In yet another embodiment, a base station in a wireless communication system, the base station comprising: a transceiver; and a processor configured to: transmit, to a user equipment (UE), a control message including a lower layer triggered mobility (LTM) configuration for performing a LTM measurement and a timer for supervising a LTM cell switch, and receive, from the UE, a radio resource control (RRC) reestablishment message, in case that the timer for supervising the LTM cell switch is running on a second cell group, wherein the UE is associated with a first cell group and the second cell group, wherein the UE detect a radio link failure for the first cell group of the first cell group and the second cell group, while performing a LTM cell switch, wherein the UE identify whether the timer for supervising the LTM cell switch is running on the second cell group.

### Advantageous Effects of Invention

Advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

The method and the UE are illustrated in the accompanying drawings, throughout which like reference letters indicate corresponding parts in the various figures. The embodiments herein will be better understood from the following description with reference to the drawings, in which:

FIG. 1 illustrates a block diagram of a telecommunication network for handling a radio link failure while performing LTM, according to the embodiments as disclosed herein;

FIG. 2 shows various hardware components of a UE, according to the embodiments as disclosed herein;

FIG. 3 is a flow chart illustrating a method, implemented by the UE, for handling a radio link failure while performing LTM in the telecommunication network, according to the embodiments as disclosed herein;

FIG. 4 is a flow chat illustrating a failure information initiation with a tcellswitch, according to the embodiments as disclosed herein;

FIG. 5 is a flow chat illustrating an MCG failure information transfer when a LTM is configured, according to the embodiments as disclosed herein;

FIG. 6 is a flow chat illustrating a SCG failure information initiation with Tcellswitch, according to the embodiments as disclosed herein;

FIG. 7 is a flow chat illustrating a SCG failure information transfer when LTM is configured, according to the embodiments as disclosed herein;

FIG. 8 shows various hardware components of the network apparatus, according to the embodiments as disclosed herein; and

FIG. 9 is a flow chart illustrating a method, implemented by the network apparatus, for handling the radio link failure while performing LTM in the telecommunication network, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Layer 3 mobility is denoted by the handover and conditional handover (CHO). In the event of dual connectivity, the UE may execute PSCellChange or Conditional PSCellChange. The patent disclosure describes PSCellChange or Conditional PSCellChange as a form of layer 3 mobility within the context of dual connectivity. This means that handover, conditional handover, PSCellChange, Conditional PSCellChange, and other similar actions all fall under the umbrella of L3 mobility. The present disclosure also refers to PSCellChange or Conditional PSCellChange as a Secondary Cell Group (SCG) layer 3 mobility, and handover and CHO as a Master Cell Group (MCG) layer 3 mobility in the context of dual connectivity. Upon receipt of the RRC reconfiguration message requesting the UE to perform handover or the execution of conditional reconfiguration (CHO CPA or CPC), the UE may carry out L3 mobility.

In traditional approaches, the User Equipment (UE) is provided with a Radio Resource Control (RRC) configuration to facilitate updates to certain security parameters. The patent disclosure takes into account pertinent background information, including 3GPP specifications like TS38300, TS38331, TS38321, and V1720.

The 3GPP release 18 is exploring the implementation of Lower Layers Triggered Mobility (LTM), also referred to as L1/L2 layers, as a solution to address issues related to latency, signalling overhead, and other concerns associated with layer 3 mobility. According to 3GPP, the primary objective of LTM is to facilitate a seamless transition between serving cells through L1/L2 signalling, thereby minimizing latency overhead and interruption time. To achieve this, the network (such as gNB or a similar entity) may configure the UE with multiple candidate cells to enable rapid application of configurations for these cells. Each of these candidate cells can be allocated with a candidate cell identifier and a candidate cell configuration which can contain a RRC Reconfiguration message to be executed when the network moves the UE to that candidate cell through LTM. Additionally, the network may send a Medium Access Control Control-Element (MAC CE) or L1 signalling to dynamically switch the UE from the source cell to one of the configured candidate cells. It is noteworthy that LTM is triggered based on L1 measurements, rather than L3 measurements.

The 3GPP proposes a method for performing LTM that avoids resetting lower layers such as MAC to prevent data loss and minimize additional data recovery delays whenever possible. Additionally, the gNB may configure LTM candidate cells through a single RRCReconfiguration message for a candidate target cell or through a CellGroupConfig for each candidate target cell, or through any similar RRC structure or IE that contains similar fields. For instance, a new IE LTM-CandidateConfig could be defined as an ASN1 sequence containing CellGroupConfig and other information elements in the RRCReconfiguration. The gNB may also modify or release the candidate configurations, while the UE can store the LTM configuration of other candidate cells even after moving to the candidate cell through the LTM. Furthermore, the gNB can provide the UE with configuration for performing LTM measurements for different candidate frequencies and candidate cells and reporting based on the performed LTM measurements. Thus performing LTM involves various steps such as receiving the configuration for LTM, performing measurements needed for LTM, reporting the measurements to the network, receiving a MAC CE such as a cell switch command from the network and executing the cell switch.

Measurement Configuration: For the NR R17, the UE can be configured with MeasConfig IE for performing layer 3 measurements. The NR R17 v17.2.0 NR specification defines MeasConfig as below.

MeasConfig ::= SEQUENCE {
measObjectToRemoveList MeasObjectToRemoveList OPTIONAL, -- Need N
measObjectToAddModList MeasObjectToAddModList OPTIONAL, -- Need N
reportConfigToRemoveList ReportConfigToRemoveList OPTIONAL, -- Need N
reportConfigToAddModList ReportConfigToAddModList OPTIONAL, -- Need N
measIdToRemoveList MeasIdToRemoveList OPTIONAL, -- Need N
measIdToAddModList MeasIdToAddModList
OPTIONAL, -- Need N
s-MeasureConfig CHOICE {
ssb-RSRP RSRP-Range,
csi-RSRP RSRP-Range
}
OPTIONAL, -- Need M
quantityConfig QuantityConfig
OPTIONAL, -- Need M
measGapConfig MeasGapConfig
OPTIONAL, -- Need M
measGapSharingConfig MeasGapSharingConfig OPTIONAL, -- Need M
...,
[[
interFrequencyConfig-NoGap-r16 ENUMERATED {true} OPTIONAL -- Need R
]]
}

The additional details and definitions of all the parameters for MeasConfig are present in TS 38.331 V17.2.0.

LTM measurements: The gNB has the ability to configure the UE with various measurement configurations for both layer 3 mobility, utilizing the MeasConfig IE in R17 NR, and the LTM. The UE, which has been configured with measurement configurations for layer 3 mobility (commonly referred to as L3 measurements, configured through R17 MeasConfig IE), as well as the LTM (referred to as LTM measurements), performs both types of measurements. It is important to note that LTM measurements are considered L1 measurements.

The L1 measurement report for the LTM is periodically reported via the Physical Uplink Control Channel (PUCCH), semi-persistently reported through the PUCCH/Physical Uplink Shared Channel (PUSCH), and aperiodically reported on the PUSCH. Additionally, the MAC CE may be utilized for reporting L1 measurements. These reports may be scheduled by the gNB or initiated by the UE. Moreover, the gNB may decide on the LTM through uplink (UL) measurements.

Cell Switch command: The gNB issues instructions to the UE to execute the LTM, prompting it to transition to the target candidate cell either through a Downlink (DL) MAC CE or via L1 signalling. The MAC CE triggering the cell switch carries crucial LTM-related information, including the cell identifier. The process of initiating a change in cells using the LTM feature is known as the cell switch. This procedure supports both RACH-based (Contention Free Random Access (CFRA) Contention Based Random Access (CBRA)) and RACH-less methods for the cell switch. The RACH-less cell switch is suitable when the UE does not require Timing Advance (TA) during the cell switch. The RACH resource for CFRA for cell switch can be provided to the UE in the RRC configuration.

The LTM cell switch is overseen by a timer, denoted as Tcellswitch in the patent disclosure. The network is notified of the UE's arrival in the target cell through uplink signaling, either via MAC or RRC signaling. Upon receipt of the cell switch command, the timer is initiated and ceases once the cell switch is finalized. One option is to designate Tcellswitch as a novel timer, while another option involves utilizing the existing NR RRC R17 timer T304 to monitor LTM cell switch. All embodiments described in the present disclosure for Tcellswitch are also relevant to T304 when used for LTM, including the supervision of LTM cell switch.

The Cell switch is completed once the UE successfully completes random access for RACH based cell switch. For RACH less cell switch, the cell switch may be completed once a UL transmission is successful (for e.g., the UL transmission for indicating the target cell). In Release 18 NR, the LTM is supported in dual connectivity, for e.g. in NR-DC where both MN and SN are NR nodes (gNB).

Dual Connectivity: Dual connectivity or more technically multi-radio dual connectivity is specified by the 3GPP in specifications such as TS 37.340. A summary of the details on the dual connectivity and measurement gap operations with dual connectivity are given below.

The NG-RAN facilitates Multi-Radio Dual Connectivity (MR-DC) operation, wherein the UE in RRC_CONNECTED is configured to employ radio resources provided by two distinct schedulers situated in separate NG-RAN nodes. These nodes are connected via a non-ideal backhaul, with one providing access to NR (New Radio) and the other to either E-UTRA (Evolved UMTS Terrestrial Radio Access) or NR. One node serves as the master node (MN), while the other functions as the secondary node (SN). These nodes are linked via a network interface, and at least the MN is connected to a core network. The cell groups associated to the MN can be referred to as the MCG and the cell groups associated to the SN can be referred to as SCG.

The NG-RAN also supports NG-RAN E-UTRA-NR Dual Connectivity (NGEN-DC) wherein the UE is connected to an ng-eNB (an E-UTRA base station capable of connecting to a 5G core) that operates as the MN, and one gNB (5G base station) that serves as the SN. Additionally, the NG-RAN enables NR-E-UTRA Dual Connectivity (NE-DC) where the UE is connected to a gNB that functions as the MN, and an ng-eNB that serves as the SN.

From R17 onwards, the gNB may activate or deactivate SCG using the RRC Message. Based on certain conditions, the UE may perform random access during SCG activation.

SCG Failure handling: The UE sends a RRC message SCGFailureInformation to report SCG failures to the MN. The purpose of the procedure is to inform the MN about an SCG failure the UE has experienced i.e., SCG radio link failure, failure of SCG reconfiguration with sync, SCG configuration failure for RRC message on SRB3, SCG integrity check failure, and consistent uplink LBT failures on PSCell for operation with shared spectrum channel access. The SCG Failure is described in detail in 3GPP specifications such as TS 37.340 TS38.300, TS 38.331 etc.

According to TS 37.340 v17.2.0, the UE supports the following SCG failure.
SCG RLF;
SCG beam failure while the SCG is deactivated;
SN addition/change failure;
For EN-DC, the NGEN-DC and NR-DC, SCG configuration failure or CPC (Conditional PSCell Change) configuration failure (only for messages on the signalling radio bearer SRB3);
For EN-DC (Dual connectivity where the MN is a LTE node connected to a LTE core network), the NGEN-DC (Dual connectivity where the MN is a LTE node connected to a NR core network) and NR-DC, SCG RRC integrity check failure (on the signalling radio bearer SRB3);
For EN-DC, the NGEN-DC and NR-DC, consistent UL Listen Before Transmit (LBT) failure on PSCell;
For IAB-MT, reception of a BH RLF indication from SCG; and
CPA/CPC execution failure.

Upon the SCG failure, if MCG transmissions of radio bearers are not suspended i.e. when it is possible for the UE to transmit the information to MN on the MCG radio bearers, the UE suspends SCG transmissions for all radio bearers and also suspends transmission on any, Backhaul Radio Link Control (BH RLC) channels configured, if the SCG failure is not triggered by SCG beam failure and reports the SCGFailureInformation to the MN, instead of triggering re-establishment. If the SCG failure is detected while the MCG transmissions for all radio bearers are suspended, the UE initiates the RRC connection re-establishment procedure.

The SCGFailureInformation is defined as follows in TS38.331 v17.2.0

```
  ASN1START
  TAG-SCGFAILUREINFORMATION-START
  SCGFailureInformation ::= SEQUENCE {
  criticalExtensions CHOICE {
  scgFailureInformation SCGFailureInformation-IEs,
  criticalExtensionsFuture SEQUENCE { }
  }
  }
  SCGFailureInformation-IEs ::= SEQUENCE {
  failureReportSCG FailureReportSCG OPTIONAL,
  nonCriticalExtension SCGFailureInformation-v1590-IEs OPTIONAL
  }
  SCGFailureInformation-v1590-IEs ::= SEQUENCE {
  lateNonCriticalExtension OCTET STRING OPTIONAL,
  nonCriticalExtension SEQUENCE { } OPTIONAL
  }
  FailureReportSCG ::= SEQUENCE {
  failureType ENUMERATED {
  t310-Expiry, randomAccessProblem,
  rlc-MaxNumRetx,
  synchReconfigFailureSCG, scg-ReconfigFailure,
  srb3-IntegrityFailure, other-r16, spare1},
  measResultFreqList MeasResultFreqList OPTIONAL,
  measResultSCG-Failure OCTET STRING (CONTAINING MeasResultSCG-
Failure) OPTIONAL,
  ...,
  [[
  locationInfo-r16 LocationInfo-r16 OPTIONAL,
  failureType-v1610 ENUMERATED {scg-lbtFailure-r16, beamFailureRecov-
eryFailure-r16,
  t312-Expiry-r16, bh-RLF-r16, beamFailure-r17, spare3, spare2, spare1} OPTIONAL
  ]],
  [[
  previousPSCellId-r17 SEQUENCE {
  physCellId-r17 PhysCellId,
  carrierFreq-r17 ARFCN-ValueNR
  } OPTIONAL,
  failedPSCellId-r17 SEQUENCE {
  physCellId-r17 PhysCellId,
  carrierFreq-r17 ARFCN-ValueNR
  } OPTIONAL,
  timeSCGFailure-r17 INTEGER (0..1023) OPTIONAL,
  perRAInfoList-r17 PerRAInfoList-r16 OPTIONAL
  ]]
  }
  MeasResultFreqList ::= SEQUENCE (SIZE (1..maxFreq)) OF MeasResult2NR
  TAG-SCGFAILUREINFORMATION-STOP
  ASN1STOP
```

Fast MCG link Recovery: The NR UE sends the MCGFailureInformation to report MCG failures to the SCG, i.e., MCG radio link failure. The patent disclosure refers the MCGFailureInformation, in general, to any RRC message send by the UE to the network to inform about MCG RLF through SCG i.e., in a new wireless technology the message could be different. The fast MCG link recovery procedure may be performed by the network after receiving MCGFailureInformation. The network sends the MCG reconfiguration message through the SCG to recover the MCG. The UE starts a timer known as T316 timer after initiating MCGFailureInformation. If the UE does not receive MCG reconfiguration before the expiry of the timer, the UE initiates a RRC Reestablishment procedure. The Fast MCG link recovery is explained detailed in 3GPP specifications like TS 38.331. The patent disclosure is based on v17.2.0 of TS38.331. The MCGFailureInformation is defined as below in TS38.331 v17.2.0.

MCGFailureInformation: The MCGFailureInformation message is used to provide information regarding NR MCG failures detected by the UE.

```
  Signalling radio bearer: SRB1
  RLC-SAP: AM
  Logical channel: DCCH
  Direction: UE to Network
  MCGFailureInformation message
  ASN1START
  TAG-MCGFAILUREINFORMATION-START
  MCGFailureInformation-r16 ::= SEQUENCE {
  criticalExtensions CHOICE {
  mcgFailureInformation-r16 MCGFailureInformation-r16-IEs,
  criticalExtensionsFuture SEQUENCE { }
  }
  }
  MCGFailureInformation-r16-IEs ::= SEQUENCE {
  failureReportMCG-r16 FailureReportMCG-r16 OPTIONAL,
  lateNonCriticalExtension OCTET STRING
  OPTIONAL,
  nonCriticalExtension SEQUENCE { }
  OPTIONAL
  }
  FailureReportMCG-r16 ::= SEQUENCE {
  failureType-r16 ENUMERATED {t310-Expiry, randomAccessProblem, rlc-
MaxNumRetx,
  t312-Expiry-r16, lbt-Failure-r16, beamFailureRecoveryFailure-r16,
  bh-RLF-r16, spare1}
  OPTIONAL,
  measResultFreqList-r16 MeasResultList2NR
  OPTIONAL,
  measResultFreqListEUTRA-r16 MeasResultList2EUTRA OPTIONAL,
  measResultSCG-r16 OCTET STRING (CONTAINING MeasResultSCG-Failure)
OPTIONAL,
  measResultSCG-EUTRA-r16 OCTET STRING OPTIONAL,
  measResultFreqListUTRA-FDD-r16 MeasResultList2UTRA OPTIONAL,
  ...
  }
  MeasResultList2UTRA ::= SEQUENCE (SIZE (1..maxFreq)) OF
MeasResult2UTRA-FDD-r16
  MeasResult2UTRA-FDD-r16 ::= SEQUENCE {
  carrierFreq-r16 ARFCN-ValueUTRA-FDD-r16,
  measResultNeighCellList-r16 MeasResultListUTRA-FDD-r16
  }
  MeasResultList2EUTRA ::= SEQUENCE (SIZE (1..maxFreq)) OF
MeasResult2EUTRA-r16
  TAG-MCGFAILUREINFORMATION-STOP
  ASN1STOP
```

Accordingly, the embodiment herein is to provide a method for handling a radio link failure while performing LTM in a telecommunication network. The method includes receiving, by a UE, a LTM configuration for performing LTM measurement and a timer for supervising a LTM cell switch from a network apparatus in the telecommunication network. The timer for supervising LTM cell switch may be started by the UE when the UE receives the MAC Control Element (CE) for LTM cell switch from the gNB. Further, the method includes detecting, by the UE, a RLF of at least one cell group. Further, the method includes determining, by the UE, whether the timer for supervising a LTM cell switch procedure is running on other cell group. Further, the method includes performing, by the UE, one of: transmitting a RRC reestablishment message to the network apparatus, when the timer for supervising the LTM cell switch procedure is running on the other cell group, and transmitting a cell group failure information message to the network apparatus, when the timer for supervising the LTM cell switch procedure is not running.

The method is capable of effectively managing SCG and MCG failures in instances where the UE is set up for LTM measurements or receives a cell switch for the same purpose. By doing so, the UE significantly minimizes bandwidth inefficiencies in the telecommunication network.

The method involves verifying the status of Tcellswitch for a Master Cell Group (MCG). If Tcellswitch is active for MCG, the UE initiates either an RRC Reestablishment or the transmission of SCG Failure Information. However, the SCG Failure Information procedure is only initiated if the cell switch procedure is not currently running for MCG. In one embodiment, the UE triggers the SCG Failure Information procedure only when the cell switch procedure is inactive for SCG.

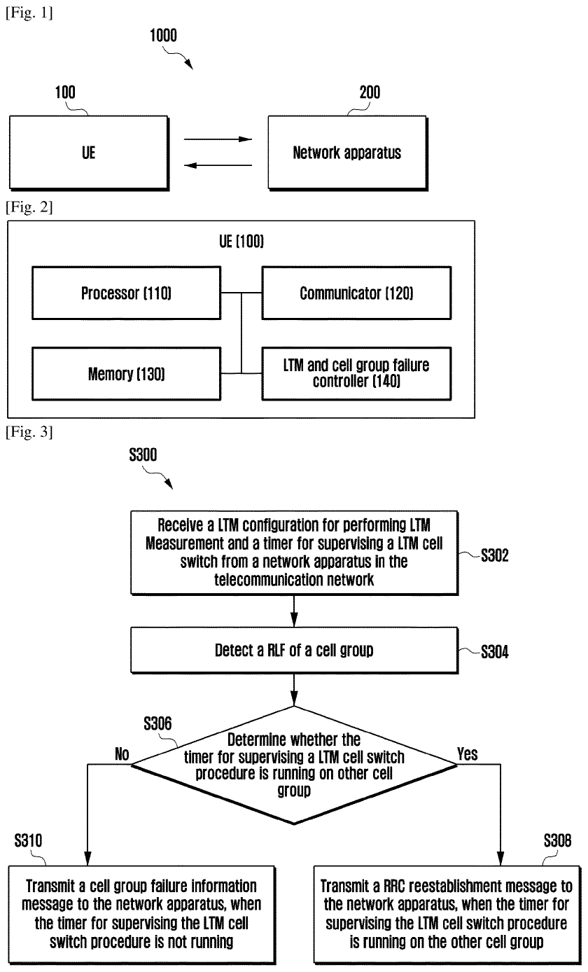

Referring now to the drawings and more particularly to FIGS. 1 through 9, where similar reference characters denote corresponding features consistently throughout the figures, there are shown preferred embodiments.

FIG. 1 illustrates a block diagram of a telecommunication network (1000) for handling a radio link failure while performing LTM, according to the embodiments as disclosed herein. The telecommunication network (1000) can be, for example, but not limited to a fourth generation (4G) network, a fifth generation (5G) network, an Open Radio Access Network (ORAN) or the like. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device.

The UE (100) receives a LTM configuration for performing LTM measurement and a timer for supervising a LTM cell switch from a network apparatus (200). The network apparatus (200) is one of a MN and a SN. Further, the LTM measurement is one of a periodic measurement, an aperiodic measurement, a semi periodic measurement, and an event-based measurement performed by the UE (100) as configured by the network apparatus (200) for the LTM. The LTM measurement is related to one of: a RSRP measurement, a SINR measurement, and a RSRQ measurement. The timer for supervising the LTM cell switch procedure can be NR timer T304.

Further, the UE (100) detects a Radio Link Failure (RLF) in at least one cell group. In one embodiment, the cell group may be either an MCG or a SCG. Furthermore, the UE (100) determines whether the timer for supervising a Long Term Evolution (LTM) cell switch procedure is active on another cell group. In one embodiment, if the timer is active on the other cell group, the UE (100) transmits a Radio Resource Control (RRC) reestablishment message to the network apparatus (200). Alternatively, in another embodiment, if the timer is not active, the UE (100) transmits a cell group failure information message to the network apparatus (200). In this embodiment, the UE (100) creates the cell group failure information message by incorporating the LTM measurement, which includes a candidate cell identifier of at least one candidate cell belonging to the cell group and the LTM measurements. The LTM measurement is a latest LTM measurement of the cell group. The term “latest” refers to the last measurements performed before sending the failure information. The UE (100) then transmits the cell group failure information message, including the LTM measurement, to the network apparatus (200). The LTM measurements reported in the cell group failure information may be the LTM measurements for that cell group or the LTM measurements configured for all the cell groups.

In an embodiment, the cell group failure information is MCGFailureInformation when the failed cell group is the MCG. The SN sends the MCGFailureInformation received including LTM measurements to the MN. By using the identifier(s) of LTM candidate cell(s) and the LTM measurements reported in the MCGFailureInformation, the MN identifies the suitable LTM candidate cells where the UE (100) can be moved to such that the MCG link can be recovered. In an embodiment, the cell group failure information is the SCGFailureInformation when the failed cell group is the SCG. By using the identifier(s) of LTM candidate cell(s) and the LTM measurements for SCG reported in SCGFailureInformation, the MN identifies suitable LTM candidate cells where the UE (100) can be moved such that the SCG link can be recovered.

Further, the UE (100) retains the LTM configuration for the designated cell group, along with the present LTM candidate cell configuration of at least one potential cell belonging to the same group, within its memory. The network apparatus (200) furnishes the UE with the current LTM candidate cell configuration for the aforementioned candidate cell. Upon evaluating the contents of the cell group failure information, the UE (100) ceases LTM measurement for the specific cell group in accordance with the LTM configuration. Stopping LTM measurements for the specific cell group upon cell group failures helps the UE (100) to save the power. This also helps avoiding unnecessary cell switches which can interfere with the cell group recovery procedure.

FIG. 2 shows various hardware components of the UE (100), according to the embodiments as disclosed herein. In an embodiment, the UE (100) includes a processor (110), a communicator, or a transceiver (120), a memory (130) and a LTM and cell group failure controller (140). The processor (110) is coupled with the communicator, or the transceiver (120), the memory (130) and the LTM and cell group failure controller (140).

The LTM and cell group failure controller (140) receives the LTM configuration for performing the LTM measurement and the timer for supervising the LTM cell switch from the network apparatus (200). Further, the LTM and cell group failure controller (140) detects the RLF of at least one cell group. In an embodiment, the cell group is at least one of the MCG and the SCG. Further, the LTM and cell group failure controller (140) determines whether the timer for supervising the LTM cell switch procedure is running on other cell group. In an embodiment, the LTM and cell group failure controller (140) transmits the RRC reestablishment message to the network apparatus (200), when the timer for supervising the LTM cell switch procedure is running on the other cell group. In another embodiment, the LTM and cell group failure controller (140) transmits the cell group failure information message to the network apparatus (200), when the timer for supervising the LTM cell switch procedure is not running. In an embodiment, the LTM and cell group failure controller (140) creates the cell group failure information message by including the LTM measurements. The LTM measurements includes the candidate cell identifier of at least one candidate cell belonging to the at least one cell group. Further, the LTM and cell group failure controller (140) transmits the cell group failure information message including the LTM measurement to the network apparatus (200).

Further, the LTM and cell group failure controller (140) stores the LTM configuration for the at least one cell group, and the current LTM candidate cell configuration of at least one candidate cell belonging to the at least one cell group in the memory (130) of the UE (100). The current LTM candidate cell configuration of the at least one candidate cell is received from the network apparatus (200). Further, the LTM and cell group failure controller (140) stops the LTM measurement for the at least one cell group based on the LTM configuration upon transmitting the cell group failure information by determining content of the cell group failure information.

The LTM and cell group failure controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the user equipment (100) and with external devices via one or more networks.

Although the FIG. 2 shows various hardware components of the UE (100) but it is to be understood that other embodiments are not limited thereon. In other embodiments, the UE (100) may include less or a greater number of components. Further, the labels or names of the components are used only for illustrative purpose and does not limit the scope of the invention. One or more components can be combined together to perform same or substantially similar function in the UE (100).

FIG. 3 is a flow chart (S300) illustrating a method for handling the radio link failure while performing LTM in the telecommunication network (1000), according to the embodiments as disclosed herein. The operations (S302-S310) are handled by the LTM and cell group failure controller (140).

At S302, the method includes receiving the LTM configuration for performing LTM measurement and the timer for supervising the LTM cell switch from the network apparatus (200). At S304, the method includes detecting the RLF of at least one cell group. At S306, the method includes determining whether the timer for supervising the LTM cell switch procedure is running on other cell group. At S308, the method includes performing transmitting the RRC reestablishment message to the network apparatus (200), when the timer for supervising the LTM cell switch procedure is running on the other cell group. At S310, the method includes transmitting the cell group failure information message to the network apparatus (200), when the timer for supervising the LTM cell switch procedure is not running.

The proposed method can be used to handle SCG and MCG failures when the UE is configured to perform LTM measurements or upon receiving cell switch for the LTM. Hence, the UE (100) reduces the bandwidth wastage in the telecommunication network (1000) and saves its power. The network apparatus (200) is able to identify a suitable cell for recovery and the services of the UE are restored immediately.

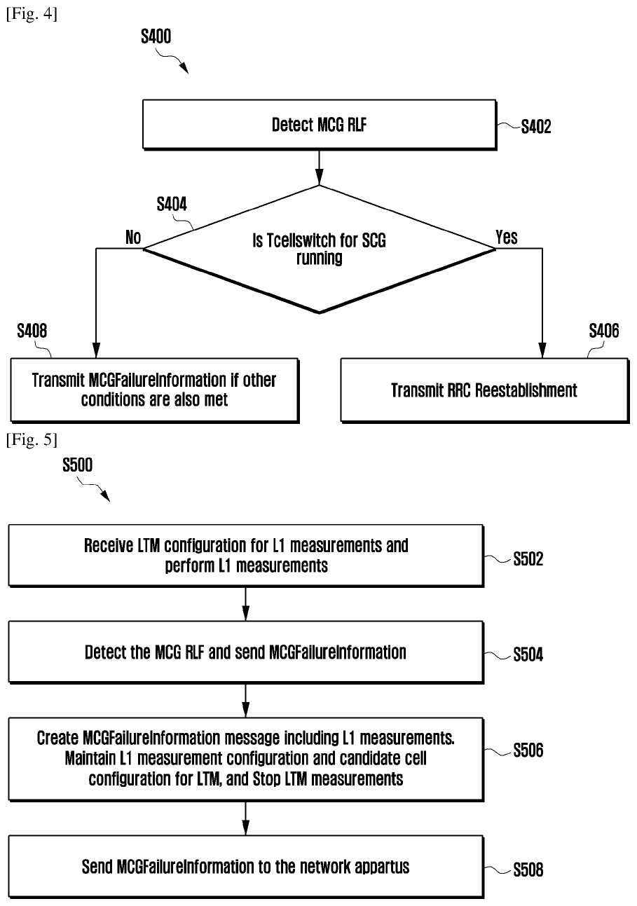

FIG. 4 is a flow chat (S400) illustrating the MCG failure information initiation with the tcellswitch, according to the embodiments as disclosed herein.

MCG Failure Information Procedure Initiation: In an embodiment, upon detecting the radio link failure of the MCG, (for e.g., in accordance with section 5.3.10.3 of TS 38.331), the UE (100) which is configured for Fast MCG Recovery in accordance with TS 38.331, determines if the Tcellswitch is running for SCG. If the Tcellswitch is running for SCG, UE (100) initiates RRC Reestablishment. Otherwise, the UE (100) initiates the transmission of MCGFailureInformation (if other conditions required for MCGFailureInformation initiation are satisfied). In other words, the MCG Failure Information procedure (for e.g., as specified in NR TS 38.331 section 5.7.3b) is initiated only when the cell switch procedure is not running for SCG.

An example specification extract in TS 38.331 with reference to v17.2.0 is given below: 5> if neither PSCell change nor PSCell addition nor cell switch is ongoing (i.e., timer T304 for the NR PSCell is not running in case of NR-DC or timer T307 of the E-UTRA PSCell is not running as specified in TS 36.331, clause 5.3.10.10, in NE-DC or timer Tcellswitch is running). 6> initiate the MCG failure information procedure as specified in 5.7.3b to report MCG radio link failure. 5> else: 6> initiate the connection re-establishment procedure as specified in 5.3.7.

As shown in FIG. 4, the operations (S402-S408) are handled by the LTM and cell group failure controller (140). At S402, the method includes detecting the MCG RLF. At S404, the method includes determining whether the Tcellswitch for SCG is running. In response to determining that the Tcellswitch for SCG is running, at S406, the method includes transmitting the RRC Reestablishment. In response to determining that the Tcellswitch for SCG is not running, at S408, the method includes transmitting the MCGFailureInformation if other conditions are also met. The other conditions include that there is no L3 mobility ongoing for the SCG, the SCG is not deactivated and the timer such as T316 in the NR is configured.

FIG. 5 is a flow chat (S500) illustrating the MCG failure information transfer when the LTM is configured, according to the embodiments as disclosed herein.

In an embodiment, determining content of MCG Failure information, UE (100) indicates that the MCGFailureInformation has failed due to the Tcellswitch expiry in the RRC message send to indicate MCG has failed. If the UE (100) is initiating the MCG Failure Information procedure due to Tcellswitch expiry, the UE (100) sets the failureType (failureType field in RRC MCGFailureInformation message) as tcellswitch-Expiry. Alternatively, a flag may be included in MCGFailureInformation to indicate that the tcellswitch has been failed.

In an embodiment, the UE (100) configured for the LTM measurements (L1 measurements for LTM) and is initiating the transmission of the MCGFailureInformation message, includes the LTM measurements, i.e., cell identifiers and L1 measurements in the MCGFailureInformation message. In an embodiment, the UE (100) includes the latest LTM measurements in the MCGFailureInformation message. In an embodiment, the UE (100) sends the average of LTM measurements over the specific period of time to the network apparatus (200) through a MCGFailureInformation message. In an embodiment, the period over which averaging is performed is received from the network apparatus (200). In an embodiment, the LTM measurements can be one of the periodic measurements, the aperiodic measurements, the semi periodic measurements or the event-based measurements performed by the UE (100) as configured by the gNB for the LTM.

In an embodiment, the LTM measurements included in MCGFailureInformation are the RSRP (Reference Signal Received Power) measurements. In an embodiment, the LTM measurements included in MCGFailureInformation are the SINR (Signal to Interference and Noise Ratio) measurements. In an embodiment, the LTM measurements included in MCGFailureInformation are the RSRQ (Reference Signal Received Quality) measurements.

In an embodiment, UE (100) includes the LTM measurements for both MCG and SCG in MCGFailureInformation.

In an embodiment, the cell identifiers included are physical cell identifiers. In an embodiment, the cell identifiers included are candidate cell identifiers configured for LTM. In an embodiment, the cell identifiers included are temporary cell identifiers configured for LTM.

In an embodiment, the UE (100) includes LTM measurements only for MCG and not for SCG in MCGFailureInformation.

In an embodiment, the UE (100) skips filtering The LTM measurements included in MCGFailureInformation according to the L3 filtering rules.

In an embodiment, the UE (100) configured with both L1 and L3 measurements for the same cell includes only L3 measurements in the MCG Failure Information. In an alternate embodiment, the UE (100) configured with both L1 and L3 measurements for the same cell includes both L1 and L3 measurements in the MCG Failure Information. The gNB may use the received L1 measurements and the cell identifiers to identify the cells where the UE could be moved during the MCG recovery procedure.

In an embodiment, the UE (100) includes the LTM measurement results available according to the current LTM measurement configuration of both the MN and the SN. Once the fast MCG link recovery is triggered, the UE (100) maintains the current LTM measurement configurations from both the MN and the SN. The UE (100) stops LTM measurements based on the configurations from the MN. This will ensure that UE doesn't unnecessarily waste its battery power with respect to MN operations. In an embodiment, the UE (100) stops the LTM measurements based on the configurations from the SN. This will ensure that the UE (100) doesn't unnecessarily waste its battery power with respect to the SN operations. This also prevents the cell switch at the SN which could lead to the failure of the MCG recovery. The UE (100) also maintains the current LTM candidate cell configurations from both the MN and the SN, thereby avoiding a need to reconfigure the LTM configurations again.

In an alternate embodiment, the UE (100) continues the measurement based on the LTM configuration from MN once the fast MCG link recovery is triggered. Such an implementation helps the UE (100) to perform the LTM cell switch for the MCG quickly when the MCG link recovery is successful.

In yet another embodiment, the UE (100) continues the measurement based on the LTM configuration from SN once the fast MCG link recovery is triggered. This will help the UE (100) to perform a LTM cell switch for SCG quickly when the MCG link recovery is successful.

In an alternate embodiment, the UE (100) clears the LTM candidate cell configuration from the MN once the fast MCG link recovery is triggered. The new reconfiguration by the MN for fast MCG link recovery may establish LTM candidates as per its updated requirements.

In yet another embodiment, the UE (100) clears the LTM candidate cell configuration from the SN once the fast MCG link recovery is triggered. The new reconfiguration by the MN for the fast MCG link recovery may establish SCG and the SCG LTM candidates as per its updated requirements.

An example specification extract according to TS 38.331 for MCGFailureInformation reporting with LTM measurements is given below

```
  FailureReportMCG-r16 ::= SEQUENCE {
  failureType-r16 ENUMERATED {t310-Expiry, randomAccessProblem, rlc-
MaxNumRetx,
  t312-Expiry-r16, lbt-Failure-r16, beamFailureRecoveryFailure-r16,
  bh-RLF-r16, spare1}
  OPTIONAL,
  measResultFreqList-r16 MeasResultList2NR OPTIONAL,
  measResultFreqListEUTRA-r16 MeasResultList2EUTRA OPTIONAL,
  measResultSCG-r16 OCTET STRING (CONTAINING MeasResultSCG-Failure)
OPTIONAL,
  measResultSCG-EUTRA-r16 OCTET STRING OPTIONAL,
  measResultFreqListUTRA-FDD-r16 MeasResultList2UTRA OPTIONAL,
  [[
  ltmMeasResults-r18 LtmMeasResults-r18 OPTIONAL
  ]]
  ...
  }
  LtmMeasResults-r18 SEQUENCE {
  ltmRSRPMeasResults-r18 LTMRSRPMeasResults-r18 OPTIONAL,
  ltmRSRQMeasResults-r18 LTMRSRPMeasResults-r18 OPTIONAL,
  ltmSINRMeasResults-r18 LTMSINRMeasResults-r18 OPTIONAL,
  }
```

The LTM measurement results are included within the FailureReportMCG sequence.

In an embodiment, the MN is a gNB and the DC is NR-NR DC, i.e. SN is also a gNB.

In an embodiment, the UE (100) configured for LTM measurements (L1 measurements for LTM) and is initiating the transmission of MCGFailureInformation message, skips including the LTM measurements, i.e., cell identifiers and L1 measurements in the MCGFailureInformation message. The UE (100) includes only L3 measurements in MCG FailureInformation message. In an embodiment, the UE (100) may include the cell identifiers for which measurements are performed/available but not the L1 measurements for the LTM candidate cells.

In an embodiment, actions after sending MCGFailureInformation, based on the LTM measurement results received, the MN decides whether there is any MCG cell available to which UE (100) can be moved to. If so, the MN may send RRC Reconfiguration message.

In an embodiment, upon reception of the MCGFailureInformation message, the MN can send RRCConnectionReconfiguration message, RRCReconfiguration message, MobilityFromNRCommand message, MobilityFromEUTRACommand message, RRCConnectionRelease message or RRCRelease message to the UE (100) using the SCG leg of split SRB1 or SRB3. Fast MCG Failure is completed when the UE (100) receives any of these messages. Upon receiving the RRCReconfiguration message, the UE (100) resumes MN and SN LTM measurements if stopped while triggering the fast MCG link recovery (and if the measurement configuration allows it).

Cell switch during Fast MCG link recovery: In an embodiment, the UE (100) stops T316 (T316 is defined in TS 38.331, the proposed invention refers V17.2.0 version of the spec) and sends the RRC Reestablishment if it receives cell switch command (for e.g., for SCG) while T316 is running. The UE (100) considers fast MCG link recovery has failed if the cell switch command is received for the SCG while the fast MCG link recovery procedure is not completed. This will help the UE (100) to recover via RRCReestablishment, since during a cell switch down link SCG transmission may be stopped and the recovery message may not reach the UE (100) till the recovery is completed.

In an embodiment, the UE (100) stops the T316 (T316 is defined in TS 38.331, the proposed invention refers V17.2.0 version of the spec) and sends RRC Reestablishment if it receives cell switch command (for e.g., for SCG) while T316 is running and the cell switch is not successful. The UE (100) considering the fast MCG link recovery has failed if the cell switch command is received for the SCG and is not successful (for e.g., due to T316 expiry) while the fast MCG link recovery procedure is not completed.

As shown in FIG. 5, the operations (S502-S508) are handled by the LTM and cell group failure controller (140). at S502, the method includes receiving the LTM configuration for the L1 measurements and performing the L1 measurements. At S504, the method includes detecting the MCG RLF and sending the MCGFailureInformation. At S506, the method includes creating the MCGFailureInformation message including the L1 measurements. The method includes maintaining the L1 measurement configuration and candidate cell configuration for the LTM. The method includes stopping the LTM measurements. At S508, the method includes sending the MCGFailureInformation to the network apparatus (200).

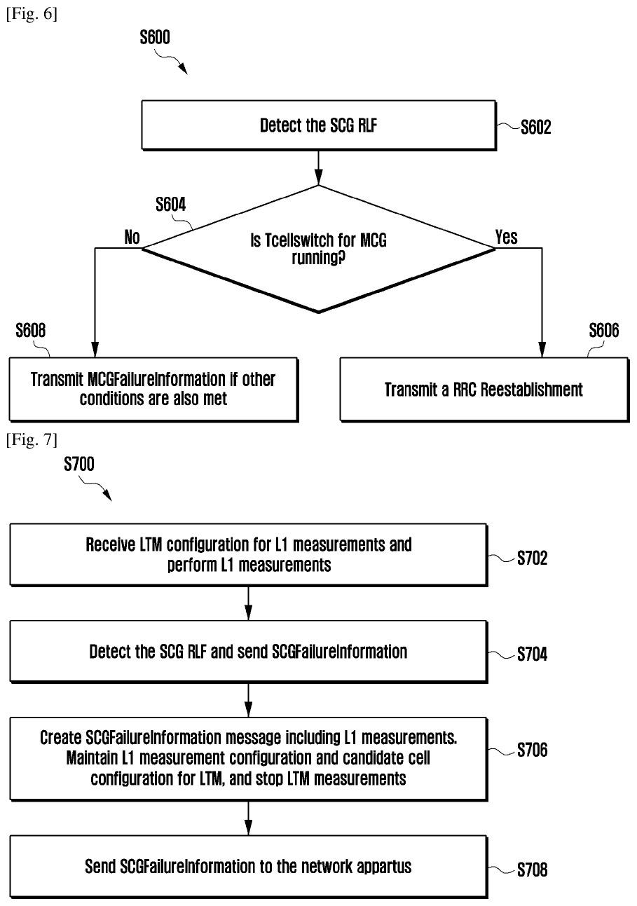

FIG. 6 is a flow chat (S600) illustrating the SCG failure information initiation with the Tcellswitch, according to the embodiments as disclosed herein.

SCG Failure Information Procedure Initiation: In an embodiment, upon detecting radio link failure of the SCG, (for e.g., in accordance with section 5.3.10.3 of TS 38.331), the UE (100) determines if Tcellswitch is running for the MCG. If the Tcellswitch is running for the MCG, the UE (100) initiates the RRC Reestablishment. Otherwise, the UE (100) initiates transmission of SCGFailureInformation (if other conditions required for SCGFailureInformation initiation are satisfied). In other words, the SCG Failure Information procedure (for e.g., as specified in NR TS 38.331 section 5.7.3) is initiated only when the cell switch procedure is not running for the MCG. In an embodiment, UE (100) initiated SCG Failure Information procedure only when the cell switch procedure is not running for SCG. In an embodiment, UE (100) may transmit SCGFailureInformation without checking if Tcellswitch for MCG is running. In yet another embodiment, the UE (100) may defer sending SCGFailureInformation until Tcellswitch for MCG is stopped.

As shown in FIG. 6, the operations (S602-S608) are handled by the LTM and cell group failure controller (140). At S602, the method includes detecting the SCG RLF. At S604, the method includes determining whether the Tcellswitch for MCG is running? In response to determining that the Tcellswitch for the MCG is running, at S606, the method includes transmitting the RRC Reestablishment. In response to determining that the Tcellswitch for MCG is not running, at S608, the method includes transmit ting the SCGFailureInformation if other conditions are also met. The other conditions include that the MCG and SCG transmissions are not suspended.

FIG. 7 is a flow chat (S700) illustrating the SCG failure information transfer when the LTM is configured, according to the embodiments as disclosed herein.

Determining content of the SCG Failure Information: the UE (100) indicating the SCG has failed due to Tcellswitch expiry in the RRC message send to indicate SCG has failed (for e.g., SCGFailureInformation). That is, the UE (100) sends an information in SCGFailureInformation that the SCGFailure is due to Tcellswitch. If the UE (100) is initiating the SCG Failure Information procedure due to Tcellswitch expiry, the UE (100) sets the failureType as tcellswitch-Expiry in SCGFailureInformation. Alternatively, a flag may be included in the SCGFailureInformation message to indicate that the SCGFailureInformation is initiated due to Tcellswitch expiry.

In an embodiment, the UE (100) configured for LTM measurements (L1 measurements for LTM) and is initiating the transmission of SCGFailureInformation message including the LTM measurements, i.e., cell identifiers and L1 measurements in the SCGFailureInformation message. In an embodiment, the UE (100) includes the latest LTM measurements in the SCGFailureInformation message. In an embodiment, the UE (100) sends the average of LTM measurements over the specific period of time to the network in the SCGFailureInformation message. The period over which averaging is done may be communicated to the UE (100) by the gNB. In an embodiment, the LTM measurements can be one of the periodic measurements, the aperiodic measurements, the semi periodic measurements or the event-based measurements performed by UE (100) as configured by the gNB for the LTM. The gNB (MN) may use the received L1 measurements and the cell identifiers to identify the SCG cells where the UE could be moved for continuing the SCG operations. The received measurements may be used for self-optimization and minimization of drive tests purposes also by various network entities.

In an embodiment, the LTM measurements included in SCGFailureInformation are the RSRP (Reference Signal Received Power) measurements. In an embodiment, the LTM measurements included in SCGFailureInformation are the SINR (Signal to Interference and Noise Ratio) measurements. In an embodiment, the LTM measurements included in SCGFailureInformation are the RSRQ (Reference Signal Received Quality) measurements.

In an embodiment, the UE (100) includes LTM measurements for both MCG and SCG in SCGFailureInformation.

In an embodiment, the cell identifiers included are physical cell identifiers. In an embodiment, the cell identifiers included are candidate cell identifiers configured for the LTM. In an embodiment, the cell identifiers included are temporary cell identifiers configured for LTM.

In an embodiment, UE (100) includes LTM measurements for SCG and not for MCG even if both are configured in SCGFailureInformation. LTM measurements are included only if LTM measurements for SCG are configured and are available.

In an embodiment, the UE skips filtering The LTM measurements included in SCGFailureInformation according to the L3 filtering rules.

In an embodiment, a UE (100) configured with both L1 and L3 measurements for the same cell includes only L3 measurements in the SCG Failure Information. In an alternate embodiment, a UE (100) configured with both L1 and L3 measurements for the same cell includes both L1 and L3 measurements in the SCG Failure Information. In an alternate embodiment, a UE (100) configured with both L1 and L3 measurements for the same cell includes both L1 and L3 measurements in the SCG Failure Information.

In an embodiment, UE (100) includes the LTM measurement results available according to the current LTM measurement configuration of both the MN and the SN. Once the SCGFailureInformation message is triggered, UE (100) maintains the current LTM measurement configurations from both the MN and the SN. In an embodiment, UE (100) stops LTM measurements based on the configurations from the SN. This will help to save the power at the UE (100). In an embodiment, the UE (100) continues the LTM measurements based on the configurations from the MN. This will help to perform any MN triggered cell switch irrespective of the failures at SCG. In an embodiment, UE (100) maintains the current LTM candidate cell configurations from both the MN and the SN. This will help the UE and the gNB to quickly restore the LTM configurations without additional signalling overhead.

In an alternate embodiment, the UE (100) continues the measurements based on the LTM configuration from the SN even after the SCGFailureInformation is send. Such implementations help to execute LTM quickly after the SCG link is recovered at the cost of some power consumption.

In yet another embodiment, the UE (100) stops the measurement based on the LTM configuration from the SN once the SCGFailureInformation is send.

In an alternate embodiment, the UE (100) clears the LTM candidate cell configuration from the MN once the SCGFailureInformation is send.

In yet another embodiment, the UE (100) clears the LTM measurement configuration from the SN once the SCGFailureInformation is send. The gNB could configure the UE (100) with a new configuration once the SCG is restored.

In an embodiment, the dual connectivity deployment scenario for the SCGFailureInformation in the patent disclosure is NR-NR DC.

As shown in FIG. 7, the operations (S702-S708) are handled by the LTM and cell group failure controller (140). At S702, the method includes receiving the LTM configuration for L1 measurements and performing the L1 measurements. At S704, the method includes detecting the SCG RLF and sending the SCGFailureInformation. At S706, the method includes creating the SCGFailureInformation message including L1 measurements. The method includes maintaining the L1 measurement configuration and candidate cell configuration for LTM. Further, the method includes stopping the LTM measurements. At S708, the method includes sending the SCGFailureInformation to the network apparatus (200).

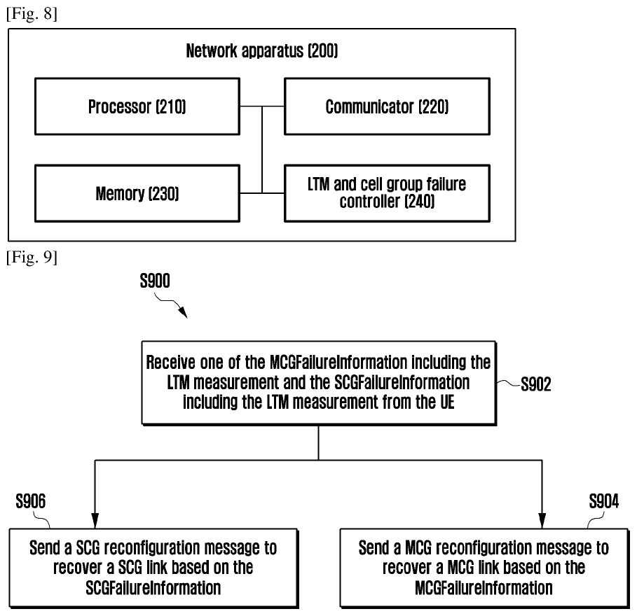

FIG. 8 shows various hardware components of the network apparatus (200), according to the embodiments as disclosed herein. In an embodiment, the network apparatus (200) includes a processor (210), a communicator or a transceiver (220), a memory (230) and a LTM and cell group failure controller (240). The processor (210) is coupled with the communicator or the transceiver (220), the memory (230) and the LTM and cell group failure controller (240).

The LTM and cell group failure controller (240) receives one of the MCGFailureInformation including the LTM measurements and the SCGFailureInformation comprising the LTM measurements from the UE (100). In an embodiment, the network apparatus receives one of: the MCGFailureInformation comprising the LTM measurement and the SCGFailureInformation comprising the LTM measurement from the UE, when a timer for supervising a LTM cell switch procedure is not running in the UE (100). In an embodiment, the LTM and cell group failure controller (240) sends the MCG reconfiguration message to recover the MCG link based on the MCGFailureInformation. In another embodiment, the LTM and cell group failure controller (240) send the SCG reconfiguration message to recover the SCG link based on the SCGFailureInformation.

The LTM and cell group failure controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

In an embodiment, the communicator (220) includes an electronic circuit specific to a standard that enables wired or wireless communication. The communicator (220) is configured to communicate internally between internal hardware components of the user equipment (100) and with external devices via one or more networks.

Although the FIG. 8 shows various hardware components of the network apparatus (200) but it is to be understood that other embodiments are not limited thereon. In other embodiments, the network apparatus (200) may include less or a greater number of components. Further, the labels or names of the components are used only for illustrative purpose and does not limit the scope of the invention. One or more components can be combined together to perform same or substantially similar function in the network apparatus (200).

FIG. 9 is a flow chart (S900) illustrating a method, implemented by the network apparatus (200), for handling the radio link failure while performing LTM in the telecommunication network (1000), according to the embodiments as disclosed herein. The operations (S902-S906) are handled by the LTM and cell group failure controller (240).

At S902, the method includes receiving one of the MCGFailureInformation including the LTM measurement and the SCGFailureInformation including the LTM measurement from the UE (100). At S904, the method includes sending the MCG reconfiguration message to recover an MCG link based on the MCGFailureInformation. At S906, the method includes sending the SCG reconfiguration message to recover a SCG link based on the SCGFailureInformation.

The various actions, acts, blocks, steps, or the like in the flow charts (S300-S700 and S900) may be performed in the order presented, in a different order or simultaneously. Further, in some embodiments, some of the actions, acts, blocks, steps, or the like may be omitted, added, modified, skipped, or the like without departing from the scope of the invention.

The present invention presents innovative method and UE for managing SCG and MCG malfunctions in situations where the UE is configured to implement Long-Term Evolution (LTM) measurements or has received a cell switch for LTM. The invention encompasses various related embodiments for configuring LTM, releasing LTM, and regulating LTM's interaction with other features and conditions. The proposed invention is used to save overall resources of the UE such as battery, performance, cost, etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method by a user equipment (UE) associated with a first cell group and a second cell group in a wireless communication system, the method comprising:
receiving, from a base station, a layer 1/layer 2 triggered mobility (LTM) configuration comprising a timer associated with a LTM cell switch;
detecting a radio link failure for the first cell group;
identifying whether the timer associated with the LTM cell switch for the second cell group is running; and
in case that the timer associated with the LTM cell switch for the second cell group is running, initiating a radio resource control (RRC) reestablishment procedure.

17. The method of claim 16, further comprising:
in case that the timer associated with the LTM cell switch for the second cell group is not running, transmitting, to the base station, first cell group failure information to report the radio link failure for the first cell group.

18. The method of claim 17,
wherein the timer associated with the LTM cell switch includes T304,
wherein the first cell group includes a master cell group (MCG) associated with a master node and the second cell group includes a secondary cell group (SCG) associated with a secondary node, and
wherein the first cell group failure information includes MCG failure information.

19. The method of claim 16, further comprising:
in case that the timer associated with the LTM cell switch for the second cell group expired, transmitting, to the base station, second cell group failure information, and
wherein a failure type indicating that a second cell group failure is associated with an expiration of the timer associated with the LTM cell switch for the second cell group is included in the second cell group failure information.

20. The method of claim 16, further comprising:
in case that the timer associated with the LTM cell switch for the second cell group expired and a timer associated with the LTM cell switch for the first cell group is running, initiating an RRC reestablishment procedure.

21. A method by a base station in a wireless communication system, the method comprising:
transmitting, to a user equipment (UE), a layer 1/layer 2 triggered mobility (LTM) configuration comprising a timer associated with a LTM cell switch; and
in case that a radio link failure for a first cell group is detected and the timer associated with the LTM cell switch is running for a second cell group, receiving, from the UE, a radio resource control (RRC) reestablishment request message.

22. The method of claim 21, further comprising:
in case that the timer associated with the LTM cell switch for the second cell group is not running, receiving, from the UE, first cell group failure information to report the radio link failure for the first cell group.

23. The method of claim 22,
wherein the timer associated with the LTM cell switch includes T304,
wherein the first cell group includes a master cell group (MCG) associated with a master node and the second cell group includes a secondary cell group (SCG) associated with a secondary node, and
wherein the first cell group failure information includes MCG failure information.

24. The method of claim 21, further comprising:
in case that the timer associated with the LTM cell switch for the second cell group expired, receiving, from the UE, second cell group failure information, and
wherein a failure type indicating that a second cell group failed failure is an expiration of the timer associated with the LTM cell switch for the second cell group is included in the second cell group failure information.

25. The method of claim 21, further comprising:
in case that the timer associated with the LTM cell switch for the second cell group expired and a timer associated with the LTM cell switch for the first cell group is running, receiving, from the UE, an RRC reestablishment request message.

26. A user equipment (UE) associated with a first cell group and a second cell group in a wireless communication system, the UE comprising:
a transceiver; and
a processor configured to:
receive, from a base station, a layer 1/layer 2 triggered mobility (LTM) configuration comprising a timer associated with a LTM cell switch,
detect a radio link failure for the first cell group,
identify whether the timer associated with the LTM cell switch for the second cell group is running, and
in case that the timer associated with the LTM cell switch for the second cell group is running, initiate a radio resource control (RRC) reestablishment procedure.

27. The UE of claim 26, wherein the processor is further configured to:
in case that the timer associated with the LTM cell switch for the second cell group is not running, transmit, to the base station, first cell group failure information to report the radio link failure for the first cell group.

28. The UE of claim 27,
wherein the timer associated with the LTM cell switch includes T304,
wherein the first cell group includes a master cell group (MCG) associated with a master node and the second cell group includes a secondary cell group (SCG) associated with a secondary node, and
wherein the first cell group failure information includes MCG failure information.

29. The UE of claim 26, wherein the processor is further configured to:
in case that the timer associated with the LTM cell switch for the second cell group expired, transmit, to the base station, second cell group failure information in case that the timer associated with the LTM cell switch for the second cell group expired, and
wherein a failure type indicating that a second cell group failure is associated with an expiration of the timer associated with the LTM cell switch for the second cell group is included in the second cell group failure information.

30. The UE of claim 26, wherein the processor is further configured to:
in case that the timer associated with the LTM cell switch for the second cell group expired and a timer associated with the LTM cell switch for the first cell group is running, initiate an RRC reestablishment procedure.

31. A base station in a wireless communication system, the base station comprising:
a transceiver; and
a processor configured to:
transmit, to a user equipment (UE), a layer 1/layer 2 triggered mobility (LTM) configuration comprising a timer associated with a LTM cell switch, and
in case that a radio link failure for a first cell group is detected and the timer associated with the LTM cell switch is running for a second cell group, receive, from the UE, a radio resource control (RRC) reestablishment request message.

32. The base station of claim 31, wherein the processor is further configured to:
in case that the timer associated with the LTM cell switch for the second cell group is not running, receive, from the UE, first cell group failure information to report the radio link failure for the first cell group.

33. The base station of claim 32,
wherein the timer associated with the LTM cell switch includes T304,
wherein the first cell group includes a master cell group (MCG) associated with a master node and the second cell group includes a secondary cell group (SCG) associated with a secondary node, and
wherein the first cell group failure information includes MCG failure information.

34. The base station of claim 31, wherein the processor is further configured to:
in case that the timer associated with the LTM cell switch for the second cell group expired, receive, from the UE, second cell group failure information, and
wherein a failure type indicating that a second cell group failed failure is an expiration of the timer associated with the LTM cell switch for the second cell group is included in the second cell group failure information.

35. The base station of claim 31, wherein the processor is further configured to:
in case that the timer associated with the LTM cell switch for the second cell group expired and a timer associated with the LTM cell switch for the first cell group is running, receive, from the UE, an RRC reestablishment request message.
